(19) United States
(12) Patent Application Publication
(10) Pub. No.: US 2008/0112190 A1
(43) Pub. Date: May 15, 2008

(54) LIGHT GUIDE PLATE HAVING RECESSED REGION(S) DISPOSED THEREON

(76) Inventors: Yu-Nan Liu, Kaohsiung County (TW); Tzu-Wei Wang, Taoyuan County (TW); Chao-Fang Chung, Ping-Tung County (TW)

Correspondence Address: NORTH AMERICA INTELLECTUAL PROPERTY CORPORATION, P.O. BOX 506, MERRIFIELD, VA, 22116, US

(21) Appl. No.: 11/681,749

(22) Filed: Mar. 2, 2007

(30) Foreign Application Priority Data
Nov. 14, 2006 (TW) 095142062

(51) Int. Cl. F21V 8/00

(52) U.S. Cl. 362/628; 362/615

(57) ABSTRACT

A light guide plate is disclosed by the present invention. The light guide plate includes a first main body having a light-exiting surface and a second main body fixed to the first main body. The second main body has a light-entering surface, and the second main body is utilized to guide light received by the light-entering surface to the first main body, wherein there is a first recessed region positioned in one side of a joint portion between the first main body and the second main body, and the first recessed region is positioned at an edge of the light-exiting surface.

### BACKGROUND OF THE INVENTION

1. Field of the Invention

The present invention relates to a light guide plate and more particularly, to a light guide plate having at least a recessed region where the light guide plate can be applied in a side-lighting type backlight module.

2. Description of the Prior Art

A backlight module is one of the most important components of a liquid crystal display (LCD), which is widely used in digital cameras, mobile phones, personal digital assistants (PDA), computer monitors, and flat panel televisions. In general, a backlight module is installed behind a display panel and includes a light source generator, a light guide plate, a reflecting sheet, a diffusion sheet, and a few types of optical films or prism sheets.

The function of the light guide plate is to guide the scattering direction of the light generated by the light source generator to increase luminance of the display panel, and ensure uniform brightness of the display panel in order to transform a point light source or a linear light source of the backlight module into a planar light source for the LCD panel. Therefore, the material property of the light guide plate, and design and manufacturing of the surface diffusion pattern are related to optical design and control of the luminance and mura of the backlight module, and the material property of the light guide plate, and design and manufacturing of the surface diffusion pattern are major considerations for the backlight module manufacturers. In general, the light guide plate is manufactured by an injection molding method by making acryl into a planar plate, and the surface diffusion pattern of the light guide plate is formed at the same time.

Please refer to FIG. 1. FIG. 1 is a cross-sectional diagram of a conventional light guide plate and a light emitting diode (LED) in a side-lighting type backlight module. As shown in FIG. 1, the conventional light guide plate 10 has a light-exiting surface 12 and a light-entering surface 1 4, and an LED 1 6 is positioned in a side of the light-entering surface 14. Since the LED 16 has an emitting angle limitation of about 110 degrees, therefore light energy emitted by the LED 16 will be leaked out from the top surface and bottom surface of the light guide plate 10. This results in problems of energy loss and bright-dark lines. Please refer to FIG. 2. FIG. 2 is an actual picture of the bright-dark lines generated by the side-lighting type backlight module utilizing the conventional light guide plate 10. Due to the energy loss factor, the amount of the LED 16 must be increased in order to attain the required luminance in the prior art. Considering the cost, power consumption, and heat dissipation issues, the prior art has serious defects, and therefore a better light guide structure is required.

### SUMMARY OF THE INVENTION

It is therefore one of the objectives of the present invention to provide a light guide plate having at least a recessed region being applied in a side-lighting type backlight module to solve the problems mentioned above.

According to the claims of the present invention, the present invention discloses a light guide plate comprising a first main body having a light-exiting surface, and a second main body fixed to the first main body. The second main body has a light-entering surface, and the second main body is utilized to guide light received by the light-entering surface to the first main body, wherein there is a first recessed region positioned in one side of a joint portion between the first main body and the second main body, and the first recessed region is positioned at an edge of the light-exiting surface.

According to the claims of the present invention, the present invention further discloses a side-lighting type backlight module comprising a light guide plate and a light source generator. The light guide plate comprises a first main body having a light-exiting surface, and a second main body fixed to the first main body. The second main body has a light-entering surface, and the second main body is utilized to guide light received by the light-entering surface to the first main body, wherein there is a first recessed region positioned in one side of a joint portion between the first main body and the second main body, and the first recessed region is positioned at an edge of the light-exiting surface. The light source generator is positioned on a side of the light-entering surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a conventional light guide plate and a light emitting diode (LED) in a side-lighting type backlight module.

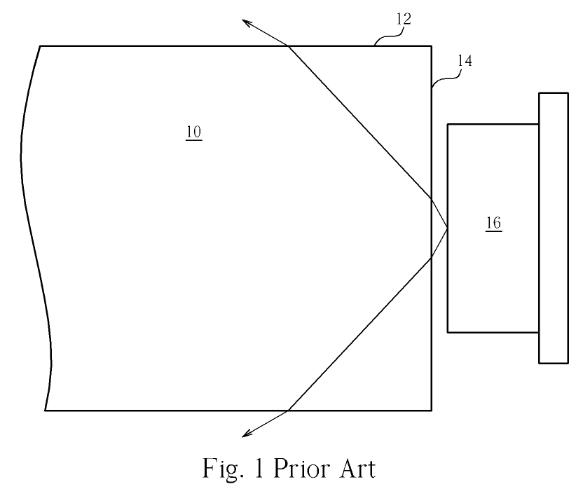

FIG. 2 is an actual picture of the bright-dark lines generated by the side-lighting type backlight module utilizing the conventional light guide plate.

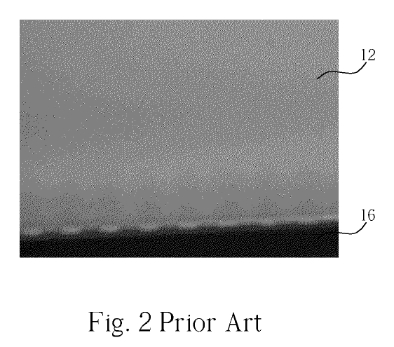

FIG. 3 is a cross-sectional diagram of a light guide plate applied in a side-lighting type backlight module according to a first embodiment of the present invention.

FIG. 4 is a cross-sectional diagram of a light guide plate applied in a side-lighting type backlight module according to a second embodiment of the present invention.

FIG. 5 is an actual picture of utilizing a light guide plate of the present invention to make a side-lighting type backlight module emit light uniformly.

### DETAILED DESCRIPTION

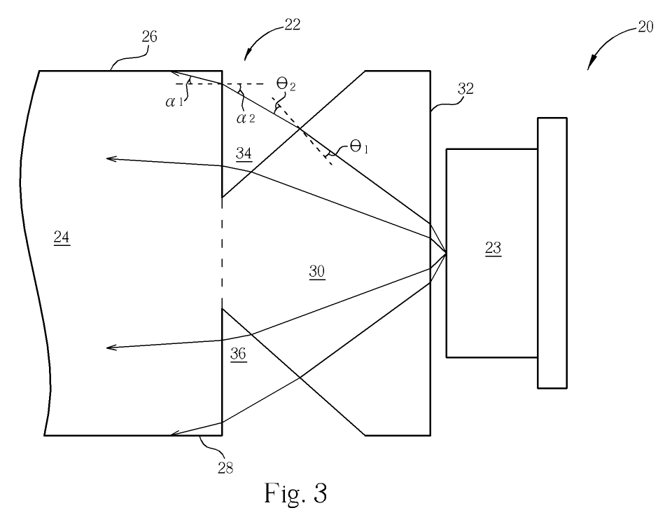

Please refer to FIG. 3. FIG. 3 is a cross-sectional diagram of a light guide plate applied in a side-lighting type backlight module according to a first embodiment of the present invention. As shown in FIG. 3, a side-lighting type backlight module 20 includes a light guide plate 22 and a light source generator 23. The light guide plate 22 includes a first main body 24 having a light-exiting surface 26 and a bottom surface 28, and a second main body 30 fixed to the first main body 24. The second main body 30 has a light-entering surface 32, and the second main body 30 is utilized to guide light received by the light-entering surface 32 to the first main body 24, wherein there is a first recessed region 34 and a second recessed region 36 positioned respectively in two sides of a joint portion between the first main body 24 and the second main body 30 (as shown in FIG. 3, the first recessed region 34 and the second recessed region 36 are positioned respectively in the top side and the bottom side of the joint portion). The first recessed region 34 is positioned at an edge of the light-exiting surface 26, and the second recessed region 36 is positioned at an edge of the bottom surface 28. Additionally, the light source generator 23 is positioned on a side of the light-entering surface 32. Please note that, although the light guide plate 22 is defined to include the first main body 24 and the second main body 30 according to the structure of the light guide plate 22 in this embodiment, the light guide plate 22 is not limited to be combined by two independent components in the present invention. For example, the first main body 24 and the second main body 30 can be formed from a single mold in a preferred embodiment of the present invention. Furthermore, the light source generator 23 can be a cold cathode fluorescent lamp (CCFL), an external electrode fluorescent lamp (EEFL), or a light emitting diode (LED), and these devices all fall within the scope of the present invention.

FIG. 3 is taken as an example to explain the function of the light guide plate 22 in the present invention. According to Snell's law:

n₁sinθ₁=n₂sinθ₂

wherein n₁ is a refractive index of the light guide plate 22, for example, the refractive index 1.49 of acryl, n₂ is the refractive index 1 of the air, θ₁ is a first incident angle in the second main body 30, and θ₂ is a first refraction angle in the first recessed region 34 and the second recessed region 36. Therefore, it is obvious that the first refraction angle θ₂ is bigger than the first incident angle 0₁, i.e. the light path will be concentrated to the first main body 24 as shown in FIG. 3.

Next, similarly according to Snell's law:

n₂sinα₂=n₁sinα₁

Wherein α₂ is a second incident angle in the first recessed region 34 and the second recessed region 36. α₁ is a second refraction angle in the first main body 24. Therefore, it is obvious that the second incident angle α₂ is bigger than the second refraction angle α₁, i.e. the light path will be concentrated to the first main body 24 as shown in FIG. 3. Thus, the light generated by the light source generator 23 will almost completely enter the first main body 24 of the light guide plate 22. Next, the light in the first main body 24 of the light guide plate 22 will be emitted uniformly on the light-exiting surface 26 via the function of a pattern (not shown) on the light guide plate 22 and a reflective sheet (not shown) positioned on the bottom surface 28 of the light guide plate 22. The function and related theory of this part are well known to a person of average skill in the pertinent art, and additional details are therefore omitted for the sake of brevity.

Please note that the cross-sectional shapes of the first recessed region 34 and the second recessed region 36 can be triangles, trapezoids, or semicircles in the present invention. The cross-sectional shapes of the first recessed region 34 and the second recessed region 36 are not limited to the right triangle shown in the first embodiment of the present invention. That is, as long as the first recessed region 34 and the second recessed region 36 can carry out the function of completely concentrating the light generated by the light source generator 23 into the first main body 24 of the light guide plate 22, then this falls within the scope of the present invention. Furthermore, the present invention is not limited to set two recessed regions at the same time. For example, in other embodiments, only setting the first recessed region 34 can also improve the defects caused by the leaking light problem of the prior art.

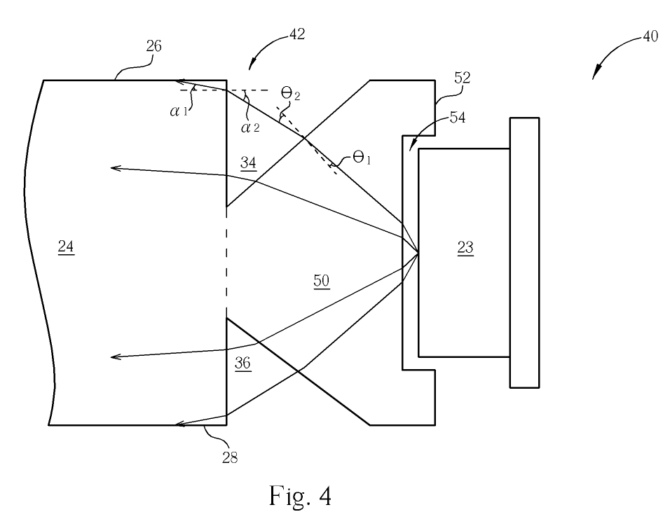

Please refer to FIG. 4. FIG. 4 is a cross-sectional diagram of a light guide plate applied in a side-lighting type backlight module according to a second embodiment of the present invention. As shown in FIG. 4, a side-lighting type backlight module 40 includes a light guide plate 42 and a light source generator 23. The light guide plate 42 includes a first main body 24 and a second main body 50. Since the second embodiment is similar to the first embodiment, most notations in FIG. 4 are continued using the notations in FIG. 3. As shown in FIG. 4, a light-entering surface 52 of the second main body 50 has a cavity 54, and the light source generator 23 is partially embedded in the cavity 54. This design can reduce the volume of the side-lighting type backlight module 40 and the design still has the same function as the first embodiment of the present invention.

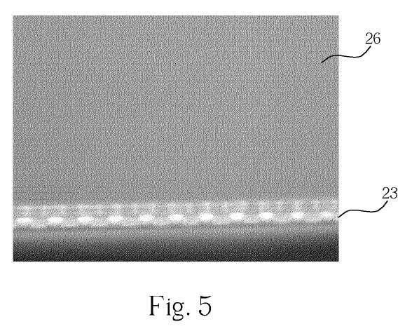

Briefly summarized, the light guide plate of the present invention can solve the problems of energy loss and bright-dark lines caused by leaking light in the top and bottom of the conventional light guide plate. Please refer to FIG. 5. FIG. 5 is an actual picture of utilizing the light guide plates 22, 42 of the present invention to make the side-lighting type backlight modules 20, 40 emit light uniformly. Additionally, applying the light guide plate of the present invention in the ordinary side-lighting type backlight module can attain the required luminance without increasing the amount of the LED. Therefore, the problems of cost, power consumption, and heat dissipation in the prior art can be solved.

Those skilled in the art will readily observe that numerous modifications and alterations of the device and method may be made while retaining the teachings of the invention. Accordingly, the above disclosure should be construed as limited only by the metes and bounds of the appended claims.

1. A light guide plate, comprising:
a first main body having a light-exiting surface; and
a second main body fixed to the first main body, the second main body having a light-entering surface, the second main body being utilized to guide light received by the light-entering surface to the first main body, wherein there is a first recessed region positioned between the first main body and the second main body along an axis perpendicular to the light-entering surface and on one side of the axis, and the first recessed region is positioned at an edge of the light-exiting surface.

2. The light guide plate of claim 1, wherein the first main body further has a bottom surface, there is a second recessed region positioned between the first main body and the second main body along the axis and on the other side of the axis, and the second recessed region is positioned at an edge of the bottom surface.

3. The light guide plate of claim 2, wherein a cross-sectional shape of the second recessed region is a triangle, a trapezoid, or a semicircle.

4. The light guide plate of claim 1, wherein a cross-sectional shape of the first recessed region is a triangle, a trapezoid, or a semicircle.

5. The light guide plate of claim 1, wherein the first main body and the second main body are formed from a single mold.

6. An side-lighting type backlight module, comprising:
a light guide plate, comprising:
a first main body having a light-exiting surface; and
a second main body fixed to the first main body, the second main body having a light-entering surface, the second main body being utilized to guide light received by the light-entering surface to the first main body, wherein there is a first recessed region positioned between the first main body and the second main body along an axis perpendicular to the light-entering surface and on one side of the axis, and the first recessed region is positioned at an edge of the light-exiting surface; and
a light source generator, positioned on one side of the light-entering surface.

7. The side-lighting type backlight module of claim 6, wherein the first main body further has a bottom surface, there is a second recessed region positioned between the first main body and the second main body along the axis and on the other side of the axis, and the second recessed region is positioned at an edge of the bottom surface.

8. The side-lighting type backlight module of claim 7, wherein a cross-sectional shape of the second recessed region is a triangle, a trapezoid, or a semicircle.

9. The side-lighting type backlight module of claim 6, wherein a cross-sectional shape of the first recessed region is a triangle, a trapezoid, or a semicircle.

10. The side-lighting type backlight module of claim 6, wherein the light-entering surface has a cavity, and the light source generator is partially embedded in the cavity.

11. The side-lighting type backlight module of claim 6, wherein the first main body and the second main body are formed from a single mold.
